(19) United States
(12) Patent Application Publication
(10) Pub. No.: US 2011/0145581 A1
(43) Pub. Date: Jun. 16, 2011

(54) MEDIA PLAYBACK ACROSS DEVICES

(75) Inventors: Abhishek Malhotra, Saharanpur (IN); T. Sahaya George, Tamil Nadu (IN); Balamuralidhar Maddali, Chennai (IN); Raju Ramakrishnan, Bangalore (IN)

(73) Assignee: VERIZON PATENT AND LICENSING, INC., Basking Ridge, NJ (US)

(21) Appl. No.: 12/636,940

(22) Filed: Dec. 14, 2009

(51) Int. Cl. H04L 9/32; H04N 7/173

(52) U.S. Cl. 713/171; 725/91

(57) ABSTRACT

A method may include displaying media items via a network, wherein the network includes a mobile device, a personal computer, and a set-top box connected to a television. A first communication session may be established with the personal computer via the network. A media item may be identified for display on the television. A request may be transmitted to the personal computer to output the identified media item for display on the television.

### BACKGROUND INFORMATION

With the advent and deployment of various consumer electronics devices, such as mobile telephones, cameras, personal computers, set-top boxes, gaming systems, etc., user content, such as media content, may be spread out across a number of different devices. For example, a user may have photos on a camera, a mobile telephone, and a personal computer.

### BRIEF DESCRIPTION OF THE DRAWINGS

FIG. 1 is a diagram of an exemplary environment in which embodiments described below may be implemented;

FIG. 2 shows an exemplary user device consistent with embodiments described herein;

FIG. 3 is a block diagram of an exemplary user device;

FIG. 4 is a block diagram of exemplary components of the mobile phone of FIG. 1;

FIG. 5 is a block diagram of exemplary components of the personal computer of FIG. 1;

FIG. 6 is a block diagram of exemplary components of the set-top box of FIG. 1;

FIG. 7 is a flowchart of an exemplary process for performing a handshaking operation between the devices of FIG. 1;

FIG. 8 is a diagram of exemplary network signals sent and received during the process of FIG. 7;

FIG. 9 is a flowchart of an exemplary process for outputting or playing back media items across the devices of FIG. 1;

FIG. 10 is a diagram of exemplary network signals sent and received during the process of FIG. 9;

FIG. 11 is a flowchart of an exemplary process for backing up or storing media items across the devices of FIG. 1;

FIG. 12 is a diagram of exemplary network signals sent and received during the process of FIG. 10;

FIG. 13 is a flowchart of an exemplary process for displaying media across the devices of FIG. 1;

FIG. 14 is a diagram of exemplary network signals sent and received during the process of FIG. 13;

FIGS. 15A-15E depict exemplary graphical user interfaces (GUIs) on consistent with implementations described in relation to FIGS. 13 and 14;

FIG. 16 is a flowchart of another exemplary process for displaying media across the devices of FIG. 1;

FIG. 17 is a diagram of exemplary network signals sent and received during the process of FIG. 16;

FIGS. 18A-18C depict exemplary GUIs consistent with implementations described in relation to FIGS. 16 and 17;

FIG. 19 is a block diagram of exemplary components of the mobile phone of FIG. 1;

FIG. 20 is a block diagram of exemplary components of the set-top box of FIG. 1; and

FIG. 21 is a flowchart of an exemplary process for transmitting event notifications between the devices of FIGS. 19 and 20.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Implementations described herein relate to devices, methods, and systems for facilitating the display of media items on various devices across a computer network, such as a local wireless network. For example, consistent with aspects described herein, a user of a mobile phone may view media content stored on a personal computer and selectively display the content either on the mobile phone or a connected television. In other aspects, the user of the mobile phone may display media items stored on the mobile phone on the television, with transcoding by the personal computer, where necessary. As used herein, the terms “viewer” and/or “user” may be used interchangeably. Also, the terms “viewer” and/or “user” are intended to be broadly interpreted to include a user device, such as a mobile phone, a set-top box (STB), and/or a television or a user of a user device, STB, and/or television.

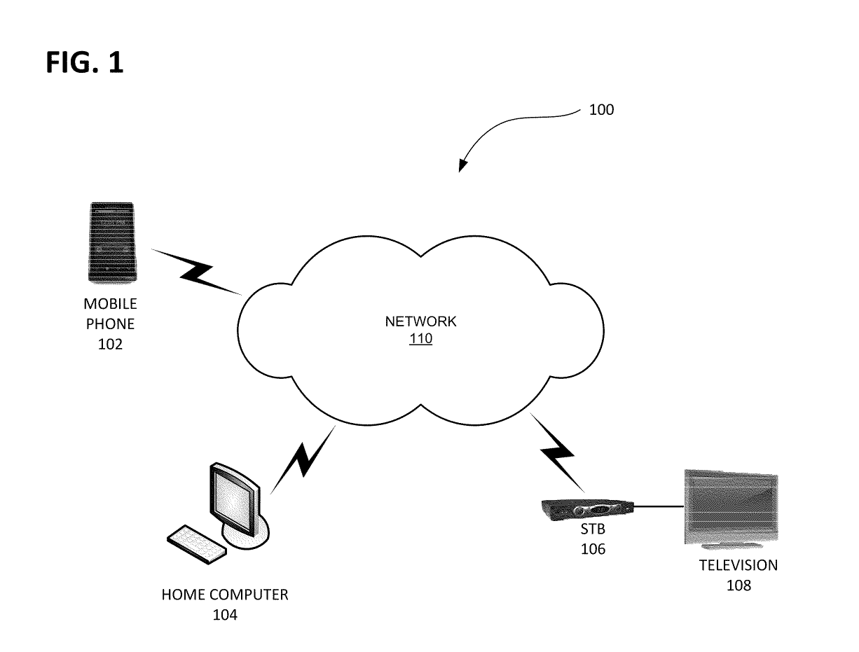

FIG. 1 is a diagram of an exemplary environment 100 in which embodiments described below may be implemented. Environment 100 includes a mobile phone 102, a computer or personal computer (PC) 104, a STB 106, a television 108 connected to STB 106, and network 110. Environment 100 is provided for exemplary purposes only, and it should be understood that environment 100 may include more or fewer devices, such as more than one mobile phone 102, computer 104, STB 106, or television 108.

Consistent with implementations described herein, a user of mobile phone 102 and PC 104 may store content (e.g., photos, music, and/or videos) on either of mobile phone 102 and/or PC 104. For example, the user of mobile phone 102 or PC 104 may download content from a computer network, such as the Internet or cellular communications network. Alternatively, the user of mobile phone 102 or PC 104 may record content with a camera associated with mobile phone 102 or PC 104. In still another embodiment, the user may record or “rip” content from a physical media, such as a compact disc or digital video disc.

Although content may be stored on mobile phone 102 or PC 104, in some circumstances, it may desirable to view or otherwise playback the content on television 108, since television 108 typically has a larger display than either PC 104 or mobile phone 102. Although it may, in some circumstances, be possible to physically connect mobile phone 102 or PC 104 to television 108 via suitable audio/visual connectors, this process may be difficult or cumbersome to perform.

Consistent with aspects described herein, media content stored on mobile phone 102 and/or PC 104 may be displayed or played back on television 108 via network 110 connecting mobile phone 102, PC 104, and STB 106. More specifically, content on PC 104 and/or mobile phone 102 may be identified and transmitted or “streamed” to STB 106 for display on television 108 via network 110. In some implementations, the instructions for identifying and transmitting the content may be received via mobile phone 102.

FIG. 1 is a simplified configuration of one exemplary environment. Other environments may include more devices or a different arrangement of devices. For example, mobile phone 102 may include any portable electronics device capable of connecting to network 110 and communicating with PC 104 and/or STB 106. In one implementation, mobile phone 102 may allow a user to place telephone calls to other user devices. Mobile phone 102 may communicate with other devices via one or more communication towers (not shown) using a wireless communication protocol, e.g., GSM (Global System for Mobile Communications), CDMA (Code-Division Multiple Access), WCDMA (Wideband CDMA), GPRS (General Packet Radio Service), EDGE (Enhanced Data Rates for GSM Evolution), etc. In one embodiment, mobile phone 102 may communicate with PC 104 and/or STB 106 through wireless local network 110 using, for example, WiFi (e.g., IEEE 802.11x) or a personal area network (PAN) protocol, such as Bluetooth®.

In addition to a mobile phone, device 102 may include, for example, a smart phone, a Personal Digital Assistant (PDA), a portable media player, a netbook and/or another type of communication device. Any of these devices may be considered “mobile phones” or “user devices” for the purposes of this description.

Computer 104 may include a laptop, desktop, or any other type of computing device. Computer 104 may include a file storage system for storing and indexing content (e.g., media content) on computer 104. Computer 104 may communicate with other devices, e.g., STB 106 and/or mobile phone 102 via network 110 using, for example, WiFi (e.g., IEEE 802.11x). In other embodiments, computer 104 may communicate with other devices via a wired network, such as an Ethernet network.

STB 106 may include a device that receives television programming (e.g., from service provider), and provides the television programming to television 108 or another device. STB 106 may allow a user to alter the programming provided to television 108 based on a signal (e.g., a channel up or channel down signal, etc.) from a remote control or another device, such as mobile phone 102. In some implementation consistent with aspects described herein, STB 106 may receive instructions from mobile phone 102 and may output or otherwise display content received from mobile phone 102 and/or computer 104 for display via television 108. Although not described in relation to FIG. 1, in other exemplary implementations, features of STB 106 may be incorporated directly within television 108.

Television 108 may include a device capable of receiving and reproducing video and audio signals, e.g., a video display device. Television 108 may include a liquid crystal display (LCD), a cathode ray tube (CRT), a plasma display, a light emitting diode (LED) display, etc. Television 108 may be associated with STB 106.

Network 110 may include a local area network (LAN), a wide area network (WAN), a personal area network (PAN), a metropolitan area network (MAN), a telephone network, such as the Public Switched Telephone Network (PSTN), an intranet, the Internet, an optical fiber (or fiber optic)-based network, or a combination of networks. As described above, network 110 may include a wireless local area network (WLAN) in which devices 102, 104, and 106 communicated via WiFi (e.g., IEEE 802.11x) or Bluetooth®.

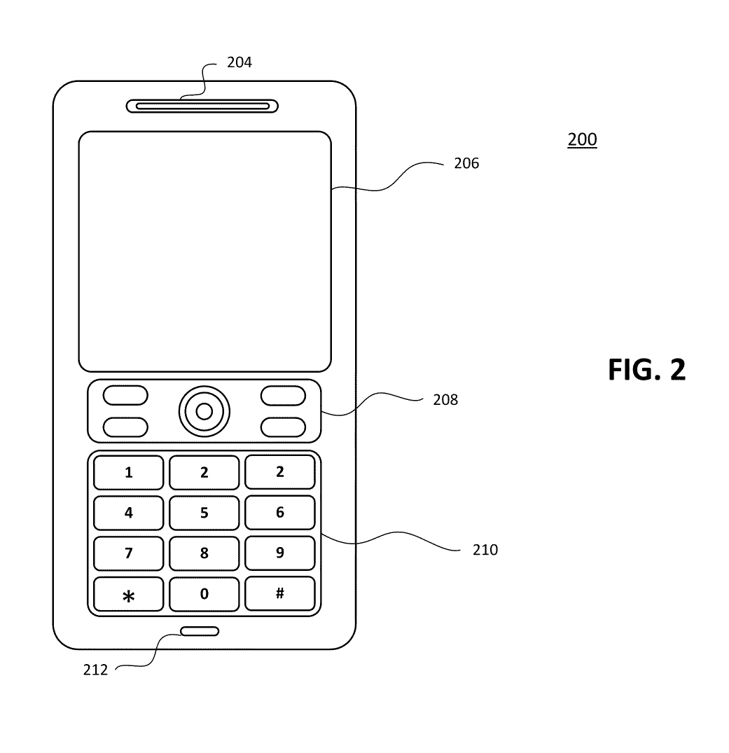

FIG. 2 is diagram of an exemplary user device 200, such as mobile phone 102. As illustrated, user device 200 may include a speaker 204, a display 206, control keys 208, a keypad 210, and a microphone 212. User device 200 may include other components (not shown in FIG. 2) that aid in receiving, transmitting, and/or processing data. Moreover, other configurations of user device 200 are possible.

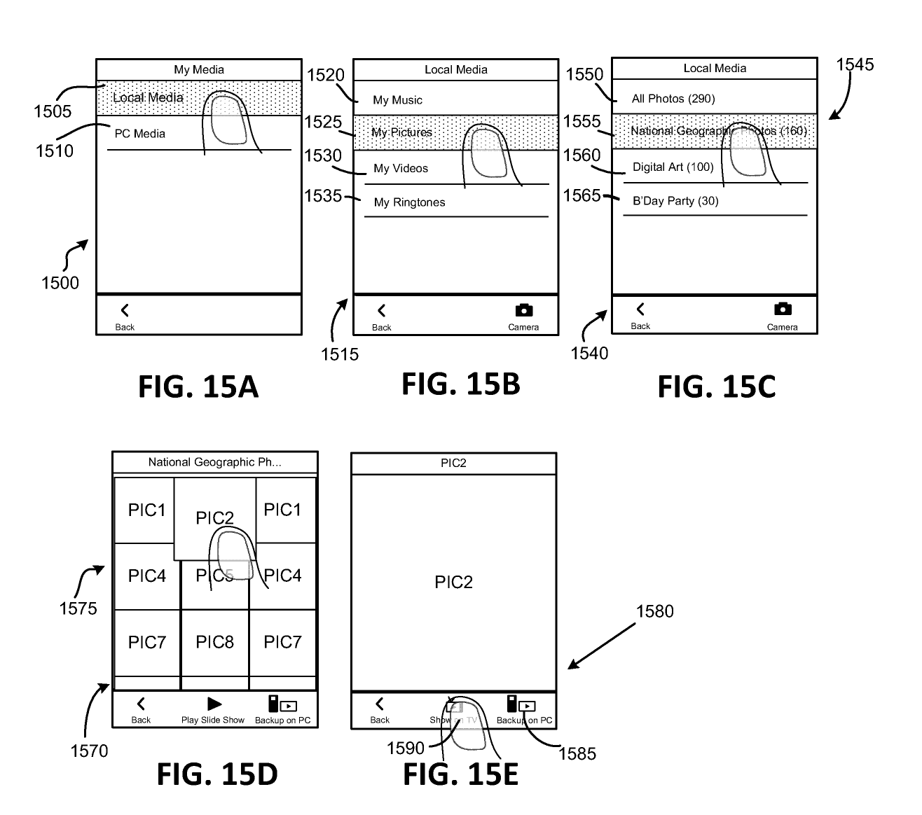

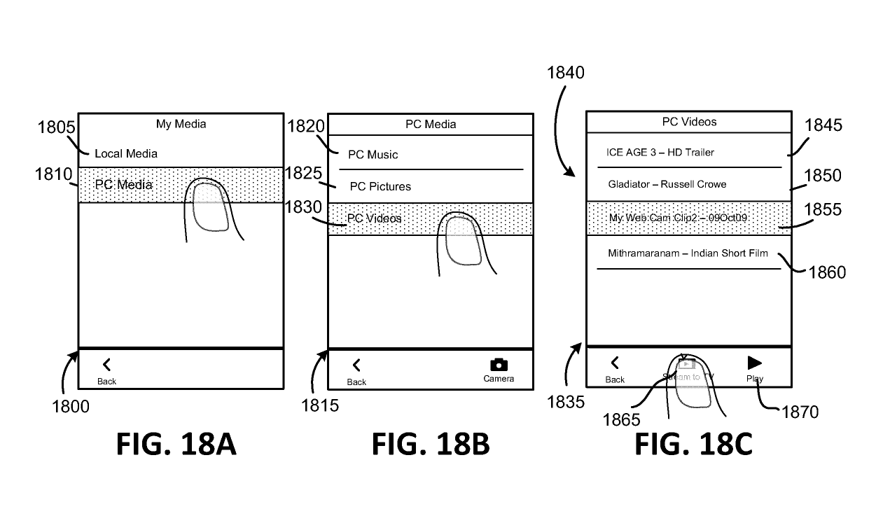

Speaker 204 may provide audible information to a user of user device 200. Display 206 may include a display screen to provide visual information to the user, such as video images or pictures, and may include a touch-screen display to accept inputs from the user. For example, display 206 may provide information regarding incoming or outgoing telephone calls, telephone numbers, contact information, current time, voicemail, email, etc. Display 206 may display the graphical user interfaces (GUIs) shown in FIGS. 15 and 18, for example.

Control keys 208 may permit the user to interact with user device 200 to cause user device 200 to perform one or more operations, such as interacting with a backup, sharing, or copying application. Control keys 208 may include soft keys that may perform the functions indicated on display 206 directly above the keys. Keypad 210 may include a standard telephone keypad and may include additional keys to enable inputting (e.g., typing) information into user device 200. Microphone 212 may receive audible information from the user.

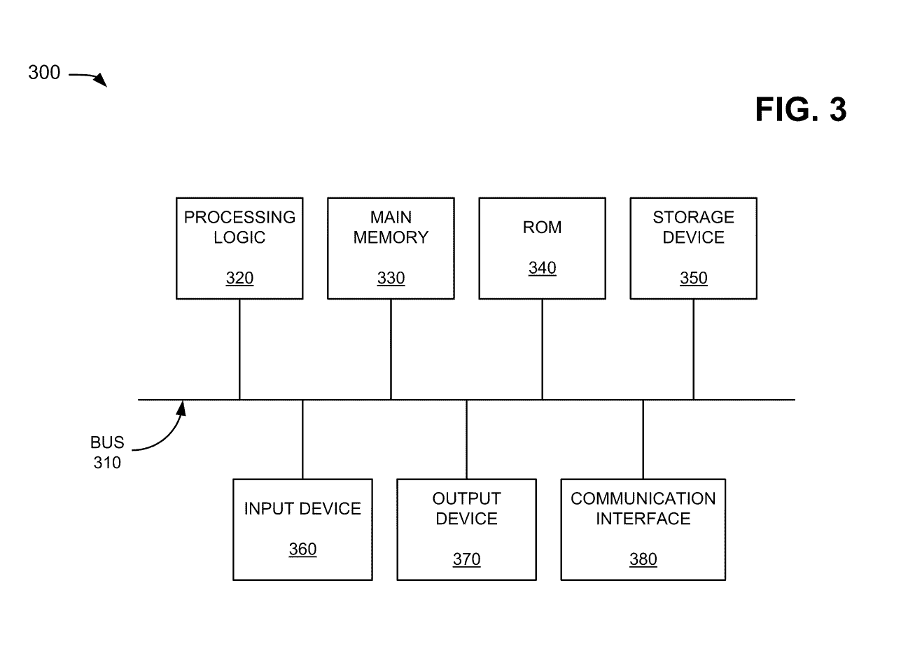

FIG. 3 is an exemplary diagram of a device 300 that may correspond to any of mobile phone 102, computer 104, and/or STB 106. As illustrated, device 300 may include a bus 310, processing logic 320, a main memory 330, a read-only memory (ROM) 340, a storage device 350, an input device 360, an output device 370, and/or a communication interface 380. Bus 310 may include a path that permits communication among the components of device 300.

Processing logic 320 may include a processor, microprocessor, or other type of processing logic that may interpret and execute instructions. Main memory 330 may include a random access memory (RAM) or another type of dynamic storage device that may store information and instructions for execution by processing logic 320. ROM 340 may include a ROM device or another type of static storage device that may store static information and/or instructions for use by processing logic 320. Storage device 350 may include a magnetic and/or optical recording medium and its corresponding drive.

Input device 360 may include a mechanism that permits an operator to input information to device 300, such as a keyboard, a mouse, a pen, a microphone, voice recognition and/or biometric mechanisms, remote control, etc. Output device 370 may include a mechanism that outputs information to the operator, including a display, a printer, a speaker, etc. Communication interface 380 may include any transceiver-like mechanism that enables device 300 to communicate with other devices and/or systems. For example, communication interface 380 may include mechanisms for communicating with another device or system via a network, such as network 110.

As described herein, device 300 may perform certain operations in response to processing logic 320 executing software instructions contained in a computer-readable medium, such as main memory 330. A computer-readable medium may be defined as a physical or logical memory device. The software instructions may be read into main memory 330 from another computer-readable medium, such as storage device 350, or from another device via communication interface 380. The software instructions contained in main memory 330 may cause processing logic 320 to perform processes described herein. Alternatively, hardwired circuitry may be used in place of or in combination with software instructions to implement processes described herein. Thus, implementations described herein are not limited to any specific combination of hardware circuitry and software.

Although FIG. 3 shows exemplary components of device 300, in other implementations, device 300 may contain fewer, different, or additional components than depicted in FIG. 3. In still other implementations, one or more components of device 300 may perform one or more other tasks described as being performed by one or more other components of device 300.

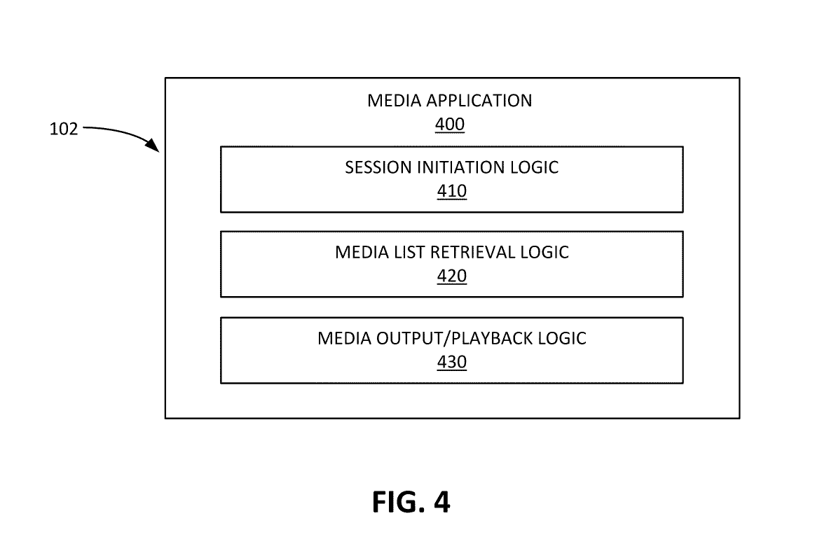

FIG. 4 is an exemplary functional block diagram of components implemented in mobile phone 102 of FIG. 1. In an exemplary implementation, all or some of the components illustrated in FIG. 4 may be stored in memory 330. For example, referring to FIG. 3, memory 330 may include a media application 400 that includes session initiation logic 410, media list retrieval logic 420, and media output/playback logic 430. In addition, various logic components illustrated in FIG. 4 may be implemented by processing logic 220 executing one or more programs stored in memory 330. In some implementations, one or more components of FIG. 4 may be implemented in other devices, such as PC 104 and/or STB 106.

In general terms, media application 400 may include a suitable combination of software and hardware configured to enable mobile phone 102 to browse and play media from or on a number of sources, such as storage device 350, PC 104, or STB 106. Session initiation logic 410 may include logic configured to establish one or more communication sessions between mobile phone 102, PC 104, and/or STB 106 for facilitating playback of media.

In one exemplary implementation, session initiation logic 410 may use simple and extensible transmission protocol (SETP) to facilitate communications and data exchange between mobile phone 102, PC 104, and STB 106. SETP may enable device discovery (also referred as “handshaking”) and interaction by defining the format of messages and commands exchanged between devices. In one exemplary implementation, SETP may be a binary protocol that resides in a device's application layer. Commands may be exchanged between devices based on command header values that trigger execution of predefined commands at a receiving device.

Consistent with implementations described herein, SETP may include a defined header and payload structure configured to enable efficient parsing and extraction of command and data related information. For example, the SETP header structure may include seventy bytes of information that includes the following fields: a one byte protocol id field; a one byte protocol version indicator field; a one byte protocol sub-version indicator field; a one byte transport identifier field; a two byte command identifier field; a one byte command sequence identifier field; a four byte timestamp value field; a six byte proxy information field, a six byte from (or source) information field; a six byte to (or destination) information field; a thirty-two byte authentication information field; a one byte subcommand field; a two byte flag information field; a two byte reserved field; and a four byte payload length field.

The protocol id field is used to identify a packet as belonging to the SETP protocol. The protocol version indicator field includes an identifier that denotes the major version of the SETP protocol. This major version can be changed either for the major functionality change or if the protocol subversion reaches its limit. The protocol sub-version field includes an identifier that denotes the sub-version of the protocol.

The transport field includes a value indicative of the transport used by the protocol to communicate with other devices. For example, as described above, a defined transport may include transmission control protocol (TCP) over WiFi, user datagram protocol (UDP) over WiFi, etc. Any suitable transmission protocol may be used in a manner consistent with implementations described herein.

The command identifier field includes a two byte value that indicates the command associated with the exchanged message (e.g., packet). All communicating devices supporting the SETP protocol may maintain a listing of commands and their respective payloads and responses. Accordingly, messages passed between devices may reference the command listing and provide payload (or subcommand) information required by the receiving device to act on the received command.

The command sequence identifier field includes a one byte value indicative of a sequence number of a transmitted packet or message. Sequence numbers are set to zero for new commands and are incremented for by one for each continuation (i.e., related to the initial command) packet until a maximum sequence number of 255 is reached. If, at this time, additional continuation packets are required, the command sequence field may be set to 1, thereby indicating that the received packet is not related to a new command.

The time stamp value field carries a value indicative of the time at which the packet was generated. For the continuation packets, the time stamp value field carries the same value as the initial packet.

The proxy information field may include the IP address of a proxy device. For example, for TCP over Internet and/or UDP over Internet transports, it may be necessary to set a proxy device (e.g., a gateway, router, firewall, etc.) for exchanged messages to enable communication between devices over the Internet.

The from or source information field may include the source address (e.g., IP address) of packet originating device. Similarly, the to or destination information field may include value representative of the destination address (e.g., IP address) of transmitted message or packet.

The authentication information field may include the session id established through the initial hand shaking As will be described below, encrypted authentication information may be exchanged between communicating devices to facilitate authentication of the devices to one another. The key or session id generating during authentication may be included in this field, to enable authentication of received packets.

The sub command includes additional information relating to a command designated in the command field. Values in the sub command field are defined based on the respective commands and are interpreted differently for different commands. The flag information field may be a two byte field used to carry the bit level information about the packet. Flags identified in the flag information field may indicate that the sending device is the originator device, that the packet has continuation packets, that the packet is a continuation packet, that the packet is a proprietary command message, that the device transmitting the packet begins the TCP channel, or that the packet denotes a big endian binary data model.

The payload length field specifies the length of a payload associated with the packet header. In one implementation, when the payload length field is zero, the packet is known as command packet. When the payload length field is not zero and carries some information, the packet is termed as a data packet. In one implementation, SETP payload data may follow the header information and may be formatted in a name, length, value (n, l, v) order. The reserved field may include no data, and is reserved for future additions to the SETP protocol.

Returning to FIG. 4, media list retrieval logic 420 may include logic configured to request and receive media information from a connected device, e.g., a device connected via a SETP communication session. Media list retrieval logic 420 may further include logic configured to display or otherwise output the received media information for browsing and selection by a user of the receiving device (e.g., mobile phone 102).

Media output/playback logic 430 may include logic configured to receive a user selection of a particular media item and initiate the output or playback of the particular media item via a selected device. For example, in one implementation, media output/playback logic 430 may be configured to receive a user selection of the particular media item (e.g., presented by media list retrieval logic 420), request the item from source of the media (e.g., PC 104), and receive/output a media stream containing the selected media item. In one example, a request for the selected media item may be made via a suitable command exchanged in the SETP communication session.

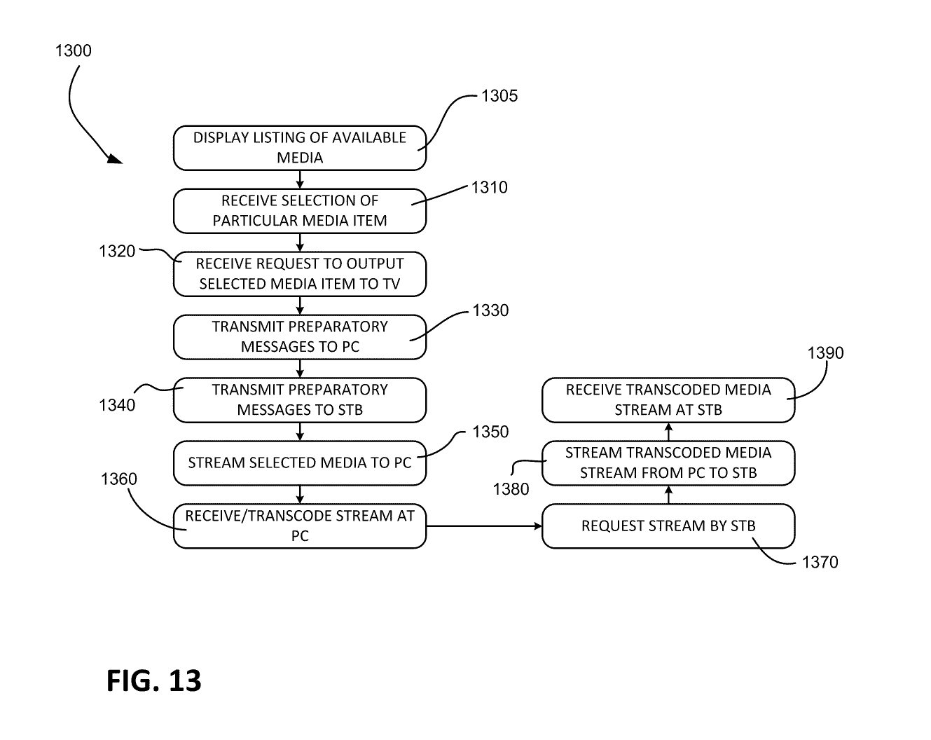

In another implementation, media output/playback logic 430 may be configured to receive a user selection of an output destination for the selected media item. For example, media playback logic 430 may receive a user selection to output the selected media item on television 108 via STB 106. In such an implementation, SETP commands may be exchanged between mobile phone 102, PC 104, and STB 106 to facilitate the streaming of the selected media item from mobile phone 102 and/or PC 104 to STB 106. Additional details regarding this implementation are set forth below with respect to FIGS. 13-16.

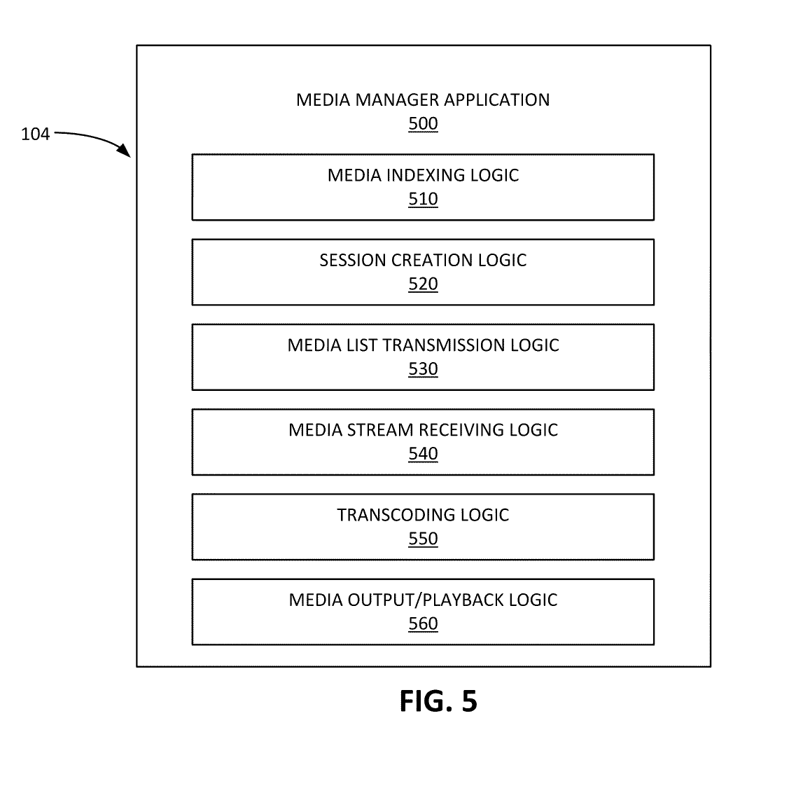

FIG. 5 is an exemplary functional block diagram of components implemented in PC 104 of FIG. 1. In an exemplary implementation, all or some of the components illustrated in FIG. 5 may be stored in memory 330 of PC 104. For example, referring to FIG. 5, memory 330 may include a media manager application 500 that includes media indexing logic 510, session creation logic 520, media list transmission logic 530, media stream receiving logic 540, transcoding logic 550, and media output/playback logic 560. In addition, various logic components illustrated in FIG. 5 may be implemented by processing logic 220 executing one or more programs stored in memory 330. In some implementations, one or more components of FIG. 5 may be implemented in other devices, such as mobile phone 102 and/or STB 106.

Media manager application 500 may include a suitable combination of software and hardware configured to enable a user of PC 104 to organize and index media content for distribution to STB 106 and/or mobile phone 102 in the manner described below. Media indexing logic 510 may include logic configured to index media content associated with PC 104, such as media content stored in storage device 350 associated with PC 104. Consistent with embodiments described herein, media indexing logic 510 may extract and store information (also referred to as metadata) for media items (e.g., photos, videos, music files, etc.) stored in PC 104. The extracted information may include media item details, such as file/media type, file path, name, title, artist, duration, etc. In some implementations, the extracted information may include a thumbnail or sample image associated with a media item.

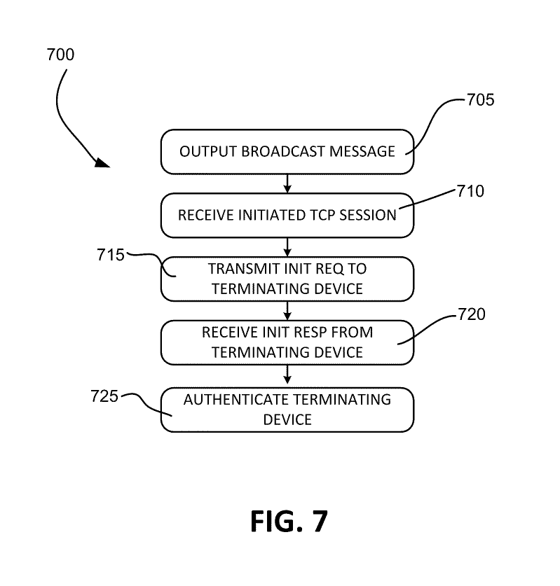

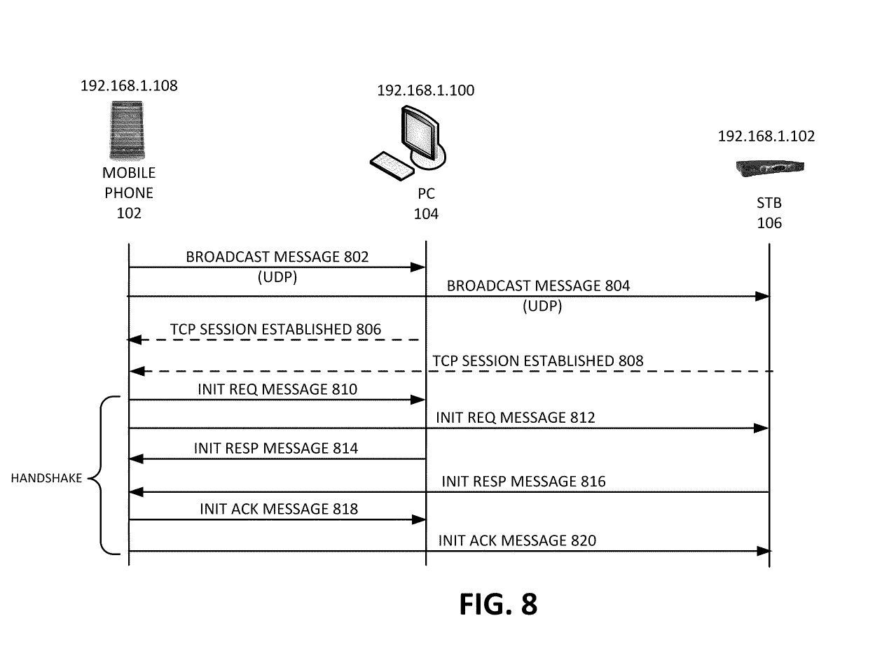

Session creation logic 520 may include logic configured to create and/or initiate a communication session with other devices on network 110, such as mobile phone 102 and/or STB 106. For example, as described above in relation to mobile phone 102, session creation logic 520 may use SETP as a lightweight and efficient means for establishing and supporting communications and data exchange between mobile phone 102, PC 104, and STB 106. Exemplary details regarding the establishment of a communication session between devices is set forth below in relation to FIGS. 7 and 8.

Media list transmission logic 530 may include logic configured to receive a media list request from a connected device, such as mobile phone 102 or STB 106, for example via the SETP communication session established by session creation logic 520. Responsive to the received request, media list transmission logic 530 may be configured retrieve and/or compile the requested listing based on the index created by media indexing logic 510 and transmit the listing to the requesting device. In some implementations, media list transmission logic 530 may be configured to authenticate received requests prior to providing the requested listing.

Media stream receiving logic 540 may include logic configured to receive a media stream from, for example, mobile phone 102. In one exemplary implementation, media stream receiving logic 540 may be configured to receive the media stream via the SETP communication session established by session creation logic 520. Media stream receiving logic 540 may be further configured to store or buffer the received media stream for subsequent output/processing by media output/playback logic 560 and/or transcoding logic 550.

Transcoding logic 550 may include logic configured to convert a media item from a first format into a second format. For example, transcoding logic 550 may include logic to convert a photo from a first resolution to a second resolution, or a video file from a first video format to a second video format compatible with an output device, such as STB 106. In one exemplary implementation, transcoding logic 550 may be configured to process a media stream received by media stream receiving logic 540. In some implementations, the processing by transcoding logic 550 may be performed in substantially real-time. That is, a media stream received by media stream receiving logic 540 (e.g., from mobile phone 102) may be transcoded by transcoding logic 550 and output via media output/playback logic with minimal delays (e.g., delays of less than approximately 30 seconds).

Media output/playback logic 560 may include logic configured to output or playback a particular media item via a selected device. For example, in one implementation, media output/playback logic 560 may be configured to receive a user selection of the particular media item and output the selected media item via output device 370 associated with PC 104 (e.g., a display). The selected media item may be stored at storage device 350 associated with PC 104, STB 106 and/or mobile phone 102.

In another implementation, media output/playback logic 560 may be configured to transmit, e.g., via a media stream, a transcoded media item to STB 106 or mobile phone 102 via one or more established communication sessions, e.g., SETP communication sessions. In other implementations, the media item may not be transcoded prior to outputting to device 102/106. In such an implementation, SETP commands may be exchanged between mobile phone 102, PC 104, and STB 106 to facilitate the streaming of the selected media item from mobile phone 102 to PC 104/STB 106 or vice/versa.

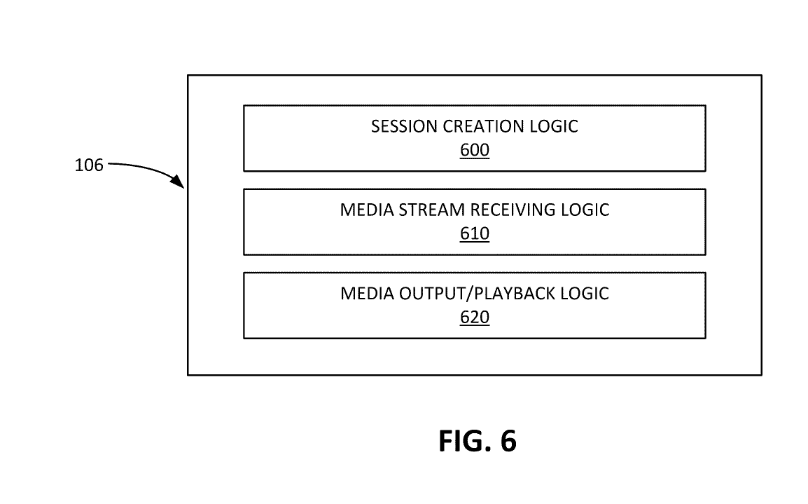

FIG. 6 is an exemplary functional block diagram of components implemented in STB 106 and/or television 108 of FIG. 1. In an exemplary implementation, all or some of the components illustrated in FIG. 6 may be stored in memory 330 of STB 106. For example, referring to FIG. 6, memory 330 may include session creation logic 600, media stream receiving logic 610, and media output/playback logic 620. In addition, various logic components illustrated in FIG. 6 may be implemented by processing logic 220 executing one or more programs stored in memory 330. In some implementations, one or more components of FIG. 6 may be implemented in other devices, such as PC 104 and/or mobile phone 102.

Session creation logic 600 may be similar to session creation logic 520 described above in relation to FIG. 5 and may include logic configured to create and/or initiate a communication session with other devices on network 110, such as mobile phone 102 and/or PC 104. For example, session creation logic 600 may establish a secure communication session with mobile phone 102 and/or PC 104 via SETP. Exemplary details regarding the establishment of a communication session between devices is set forth below in relation to FIGS. 7 and 8.

Similar to media stream receiving logic 540 described above, media stream receiving logic 610 may include logic configured to receive a media stream from, for example, PC 104. In one exemplary implementation, media stream receiving logic 610 may be configured to receive the media stream via the SETP communication session established with PC 104 by session creation logic 600. Media stream receiving logic 610 may be further configured to store or buffer the received media stream for subsequent output/processing by media output/playback logic 620.

Media output/playback logic 620 may include logic configured to output or display a particular media item, e.g., via television 108. For example, in one implementation, media output/playback logic 620 may be configured to output the media stream received by media stream receiving logic 610.

FIG. 7 is a flowchart of a process 700 for performing a handshaking operation between mobile phone 102 and PC 104 and between mobile phone 102 and STB 106. Portions of process 700 may be performed by mobile phone 102, PC 104 and/or STB 106. Process 700 is described below with respect to FIG. 8, which is a signal diagram of exemplary messages sent between devices in environment 100.

In the example of FIG. 8, mobile phone 102 has a device number or address of 192.168.1.108, PC 104 has an address of 192.168.1.100, and STB 106 has an IP address of 192.168.1.102. These addresses, commonly referred to as an Internet Protocol (IP) addresses may be assigned by a router or dynamic host configuration protocol (DHCP) server running on the router or other device in network 110. By virtue of the assigned addresses, devices 102-106 are able to exchange messages between each other via network 108, e.g., a wireless or WiFi network.

Processing may begin with mobile phone 102 (also referred to as the “originator) outputting a broadcast message (802/804) on network 110 (block 705). In one implementation, broadcast message (802/804) may be a UDP packet transmitted using a unversal IP address associated with network 110 (e.g., 255.255.255.255) and that designates a predefined port number, such as port 4732. Unlike other IP transmission protocol formats, such as TCP, UDP packets do not designate particular destination IP addresses. Additionally, packet overhead associated with UDP packets is significantly lower that the packet overhead associated with TCP packets, thereby facilitating efficient handling of UDP packets on a frequent basis without impacting the performance of the respective devices.

In some implementations, broadcast message (802/804) may support secure connections between devices. For example, broadcast message (802/804) may include an encrypted key value that may be authenticated by received devices, such as PC 104 and STB 106. In one implementation, the encryption key value included in broadcast message (802/804) may include a unique character string known to both devices in a session. For example, in one embodiment, the character string may include a user identifier (id) and password concatenated together with a nonce value representative of a time stamp generated during the broadcast packet's creation. This character string may be encrypted using, for example, a hashing scheme, such as the secure hash algorithm SHA-1 to generate a key value. Other suitable encryption algorithms, such as the message digest (MD5) algorithm, may be used.

In addition to the encrypted key value, broadcast message (802/804) may also include the above-described nonce or timestamp value to facilitate the authentication of the encrypted key value by a receiving device. More specifically, in one implementation, the receiving device (also referred to as the “terminator”), such as PC 104 or STB 106 may have independent knowledge of the user id and password shared by mobile phone 102. Upon receipt of broadcast message (802/804), the receiving device may extract the nonce value and may generate its own encrypted key value based on the known user id and password and the received nonce value. If it is determined that the key value generated by the receiving device matches the key value received in broadcast message (802/804), the transmitting device may be authenticated.

A TCP session with mobile phone 102 (806/808) may be initiated by the receiving device, e.g., PC 104 or STB 106 (block 710). For example, when the receiving device successfully authenticates the received broadcast message (802/804), the receiving device may establish a TCP session with mobile phone 102 based on IP addresses associated with the originating device and the terminating device. Once the TCP session has been established, a SETP initiation request message (810/812) may be transmitted from mobile phone 102 via the established TCP session to each respective receiving device (block 715). In one implementation, initiation request message (810/812) may include a nonce (e.g., timestamp) value as its payload.

Responsive to the received initiation request message (810/812), the terminator device may transmit a SETP initiation response message (814/816) to the originating device (e.g., mobile phone 102) (block 720). In one implementation, the payload of initiation response message (814/816) may include an encrypted (e.g., SHA-1) key value generated by the terminator device (e.g., PC 104 or STB 106) based on the shared user id and password, as well as the nonce (e.g., timestamp) value received in initiation request message (810/812).

The originating device (e.g., mobile phone 102), in response to the received initiation response message (814/816), may authenticate the terminating device (block 725). For example, the nonce value may be extracted from the payload of initiation response message (814/816). An encrypted (e.g., SHA-1) key may be generated based on the user id, password, and the extracted nonce value. The encrypted key may be compared to the encrypted key received in initiation response message (814/816). If the keys match, the terminating device may be authenticated to the originating device. If authentication has been successful, the originating device (e.g., mobile phone 102) may transmit an initiation acknowledgement message (818/820) to the authenticated terminating device (e.g., PC 104 and STB 106). In one implementation, the payload of the initiation acknowledgement message (818/820) may include the encrypted key retrieved from initiation response message (814/816). This key may be used as a session id for subsequent communications during the session. Once the devices have been successfully authenticated, additional SETP command exchanges may be performed in the manner set forth in detail below.

Consistent with implementations described herein, periodic authentication challenges may be issued by either the originating or terminating device to ensure the continued security of the established communications session. For example, exchange of keys and nonce values may be used in a manner similar to that described above. Failure on the part of either originating or terminating device may result in the closing of the communication session.

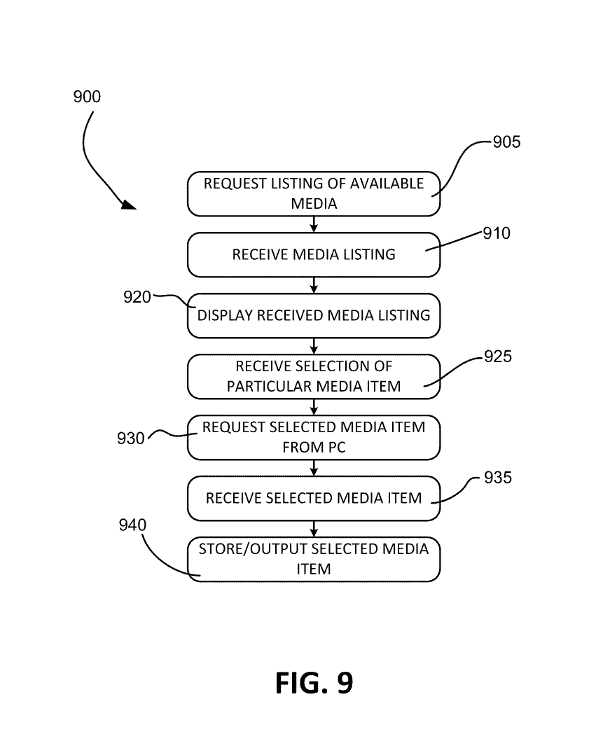

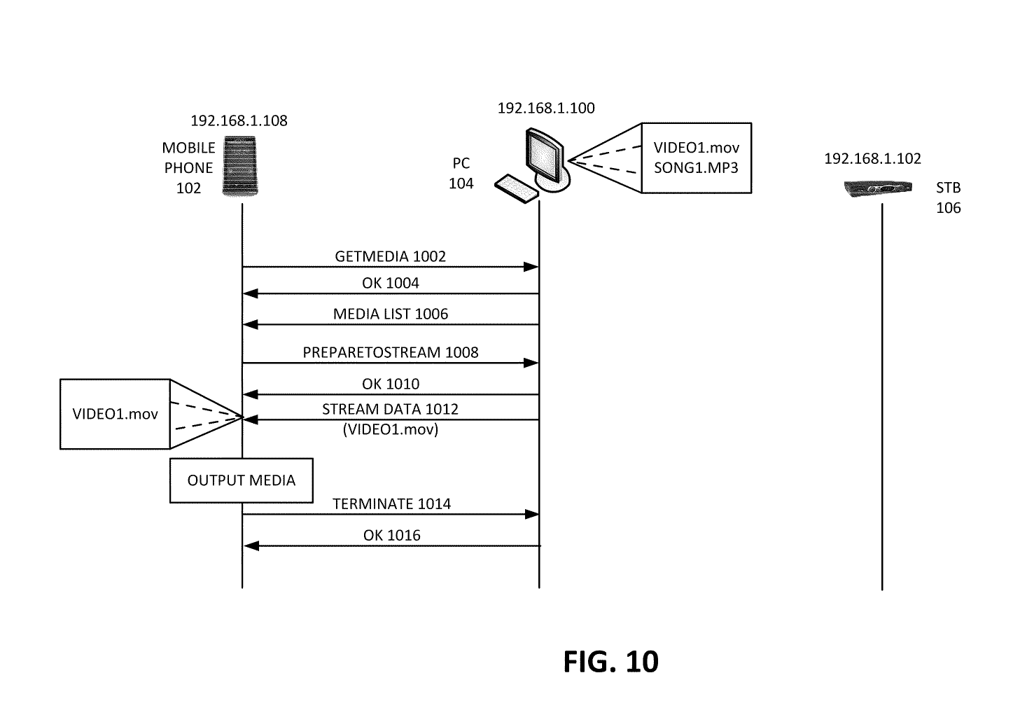

FIG. 9 is a flowchart of a process 900 for outputting or playing back media items across devices in a network. Portions of process 900 may be performed by mobile phone 102, PC 104 and/or STB 106. Process 900 is described below with respect to FIG. 10, which is a signal diagram of exemplary messages sent between devices in network 110.

For the purposes of FIGS. 9 and 10, assume that mobile phone 102 and PC 104 have successfully established a communication session therebetween, e.g., using the processes described above with respect to FIGS. 7 and 8. Moreover, assume that PC 104 includes one or more media files or items, such as video1.mov and song1.mp3 available to mobile phone 102 via the established communication session. Processing may begin with mobile phone 102 requesting a listing of available media from PC 104 (block 905). In one implementation, mobile phone 102 (also referred to as the “originator” device) may transmit a get media SETP command message (1002) to PC 104 via an established TCP session. The get media command message may be generated by media list retrieval logic 420 and may include an indication relating to the type of media list being requested, e.g., a list of shared photos, a list of shared music files, or a list of shared video files. Alternatively, the requested listing may include all available media items. Upon receipt of the get media SETP command (1002), PC 104 may initially respond with an OK message (1004) indicating successful reception of the request.

In one implementation, a number of file types or formats may be supported by media manager application 500, including image formats, such as jpeg, gif, png, and bmp, video formats, such as avi, wmv, fly, 3gp/3g2, mpg, divx, xvid, ogg-theora (ogg), mp4, and m4vf, and audio formats, such as mp3, way, aiff, mfa, aac, ogg vorbis (ogg), etc.

Mobile phone 102 may receive the requesting media listing from PC 104 (block 910). In one implementation, the media listing may be received via one or more media list SETP messages (1006). In one implementation, the media list message (1006) may include payload data that includes media item information for media items associated with PC 104, such as file types, file names, file path information, etc.

Mobile phone 102 may display the received listing to the user (block 920). For example, media list retrieval logic 420 may display the received media listing via output device 370, e.g., display 206. In some implementations, the displayed listing may include information associated with the media items, such as thumbnail images, etc. This media information may be transmitted to mobile phone 102 in the media list messages (1006), for example.

Mobile phone 102 may receive a user selection of a particular media file or item, such as a photo, a movie file, etc. (block 925). In response to this selection, mobile phone 102 may request that the selected media item be transmitted from PC 104 to mobile phone 102 (block 930). For example, mobile phone 102 may transmit a prepare to stream SETP command (1008) to PC 104. The payload associated with the prepare to stream SETP command may designate the particular media file and related information. Upon receipt of the prepare to stream SETP command, PC 104 may initially respond with an OK message (1010) indicating successful reception of the request.

Mobile phone 102 may receive the selected media item from PC 104 (block 935). For example, in response to the prepare to stream SETP command or subcommand (1008), PC 104 may generate and transmit one or more stream data SETP commands (1012). The stream data SETP commands (1012) may include payload information that includes the requested media item.

Mobile phone 102 may store and/or output the received media item (block 940). For example, media playback/output logic 430 at mobile phone 102 may display/play back the received media item via output device 370, e.g., display 206, speaker 204, etc. At any time during media item streaming, mobile phone 102 may transmit a terminate or stop command (or subcommand) (1014) to PC 104 indicating that the media stream should be terminated. For example, mobile phone 102 may receive a back or stop command from the user via one of control keys 208. In response to the terminate command (1014), PC 104 may respond with an OK message (1016) indicating successful reception of the command.

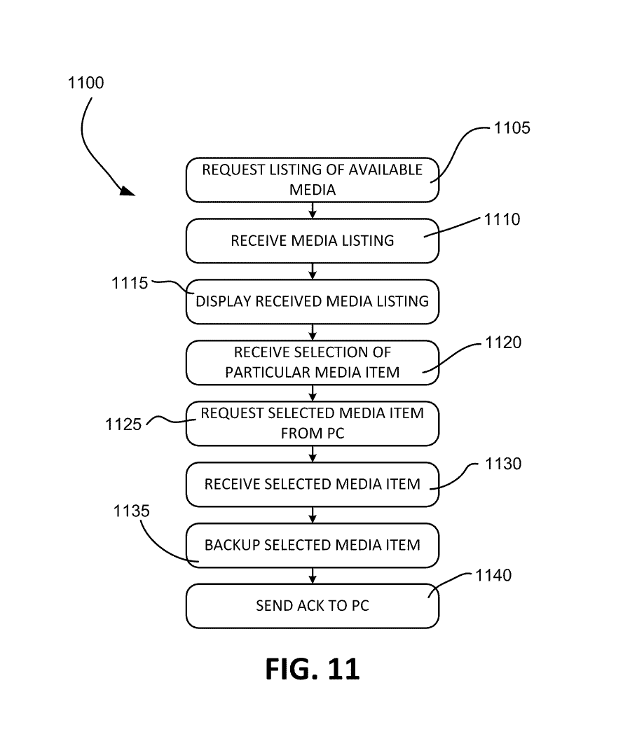

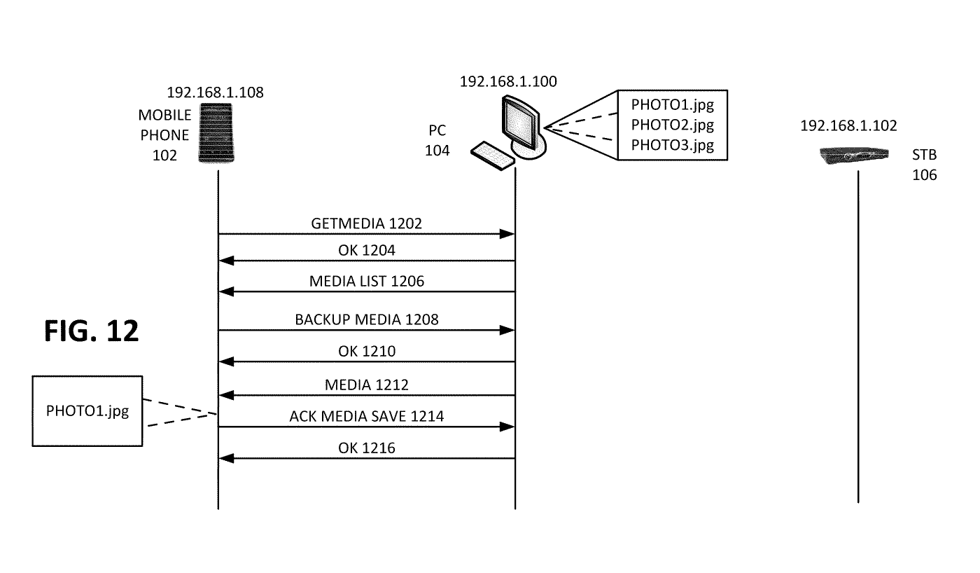

FIG. 11 is a flowchart of a process 1100 for backing up or storing media items across devices in a network. Portions of process 1100 may be performed by mobile phone 102, PC 104 and/or STB 106. Process 1100 is described below with respect to FIG. 12, which is a signal diagram of exemplary messages sent between devices in network 100.

For the purposes of FIGS. 11 and 12, assume that mobile phone 102 and PC 104 have successfully established a communication session therebetween, e.g., using the processes described above with respect to FIGS. 7 and 8. Moreover, assume that PC 104 includes one or more media files or items, such as photo1.jpg, photo2.jpg, and photo3.jpg available to mobile phone 102 via the established communication session. Processing may begin with mobile phone 102 requesting a listing of available media from PC 104 (block 1105). In one implementation, mobile phone 102 (also referred to as the “originator” device) may transmit a get media SETP command message (1202) to PC 104 via the established TCP session. In one implementation, the get media command message (1202) may be generated by media list retrieval logic 420 and may include an indication relating to the type of media list being requested, e.g., a list of shared photos, a list of shared music files, or a list of shared video files. Alternatively, the requested listing may include all available media items. Upon receipt of the get media SETP command (1202), PC 104 may initially respond with an OK message (1204) indicating successful reception of the request.

Mobile phone 102 may receive the requested media listing from PC 104 (block 1110). In one implementation, the media listing may be received via one or more media list SETP command messages 1206. In one implementation, the media list message may include payload data that includes media item information for media items associated with PC 104, such as file types, file names, file path information, etc.

Mobile phone 102 may display the received listing to the user (block 1115). For example, media list retrieval logic 420 may display the received media listing via output device 370, e.g., display 206. In some implementations, the displayed listing may include information associated with the media items, such as thumbnail images, etc. This media information may be transmitted to mobile phone 102 in the media list message (1206), for example.

Mobile phone 102 may receive a user selection of a particular media file or item for backup to mobile device 102, such as a photo, a movie file, a music file, etc. (block 1120). In response to this selection, mobile phone 102 may request that the selected media item be transmitted from PC 104 to mobile phone 102 (block 1125). For example, mobile phone 102 may transmit a backup media SETP command (1208) to PC 104. The payload associated with the backup media SETP command may designate the particular media file and related information. Upon receipt of the backup media SETP command (1208), PC 104 may initially respond with an OK message (1210) indicating successful reception of the request.

Mobile phone 102 may receive the selected media item from PC 104 (block 1130). For example, in response to backup media SETP command or subcommand (1208), PC 104 may generate and transmit one or more media messages (1212). Unlike stream data messages 1012 described above with respect to FIG. 10, media message (1212) may enable data transmission in a non-streaming manner, e.g., a manner in which quality of service (QoS) requirements are not as high. The media SETP messages (1212) may include payload information that includes the requested media item.

Mobile phone 102 may store the received media item (e.g., photo1.jpg) (block 1135). For example, mobile phone 102 may store the received media item in storage device 350. Upon complete reception of the entire media item (e.g., the entire file) mobile phone 102 may acknowledge or confirm the backup (block 1140). For example, mobile phone 102 may transmit an acknowledge media save SETP message (1214) to PC 104, indicating that the requested backup has been completed. In response to the acknowledge media save command (1214), PC 104 may respond with an OK message (1216) indicating successful reception of the command.

Although FIGS. 11 and 12 are described above in relation to selecting and backing up media items from PC 104 to mobile phone 102, in other implementations, media items may be backed up from mobile phone 102 to PC 104 in a similar manner. For example, mobile phone 102 may transmit a selected media file from mobile phone 102 to PC 104.

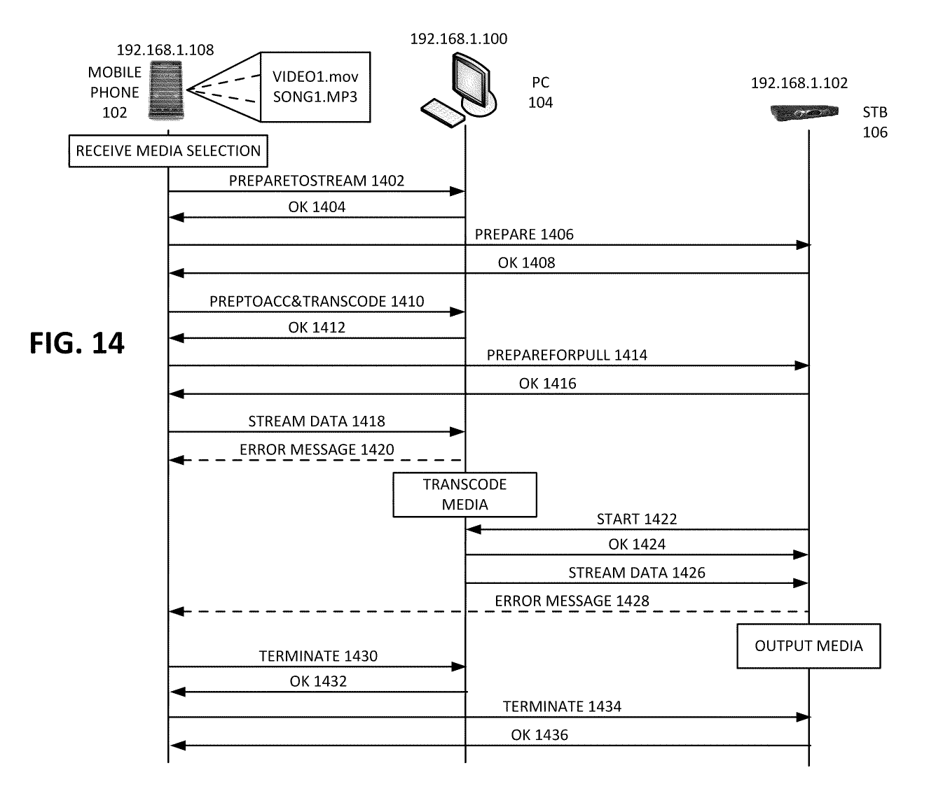

FIG. 13 is a flowchart of an exemplary process 1300 for displaying media across devices in a network. Portions of process 1300 may be performed by mobile phone 102, PC 104 and/or STB 106. Process 1300 is described below with respect to FIG. 14, which is a signal diagram of exemplary messages sent between devices in network 110.

For the purposes of FIGS. 13 and 14, assume that mobile phone 102 and PC 104, mobile phone 102 and STB 106, and PC 104 and STB 106 have all successfully established communication sessions therebetween, e.g., using the processes described above with respect to FIGS. 7 and 8. Moreover, assume that mobile phone 102 includes one or more media files or items, such as video1.mov and songl.mp3 available for playback via STB 106 via the established communication sessions. Processing may begin with mobile phone 102 displaying a listing of available media to the user (block 1305). For example, media application 400 may provide a graphical or menu driven interface, e.g., via output device 370, that displays a listing of the available media items. Mobile phone 102 may receive a user selection of a particular media item (block 1310). For example, media application 400 may receive a user selection of an item in the provided listing. In some implementations, the selected media item may be output to the user upon selection, such as an image file. In other implementations, selection of the media item may highlight the selected item for further action, such as streaming the media item to PC 104 and/or STB 106.

Mobile phone 102 may receive a user request to output the selected media item to a television (block 1320). For example, the provided interface may include an “output to TV” option made available to the user upon selection of the media item. In response to the user request, mobile phone 102 may transmit one or more preparatory messages to PC 104 (block 1330) identifying the selected media item and various parameters regarding the stream. Mobile phone 102 may also transmit one or more preparatory messages to STB 106 to prepare the STB 106 to receive the transmitted media item (block 1340).

For example, mobile phone 102 may transmit prepare to stream SETP command (1402) and prepare to accept and transcode command (1410) to PC 104 via the established TCP session. The prepare to stream (1402) and prepare to accept and transcode (1410) commands may designate and/or include information regarding the media item to be streamed and the format into which the media item is to be transmitted. In response to the prepare to stream (1402) and prepare to accept and transcode commands (1410), PC 104 may respond with OK messages (1404) and (1412), respectively, indicating successful reception of the commands.

Substantially simultaneously to the transmission of the prepare to stream command (1402), mobile phone 102 may transmit a prepare SETP command (1406) and a prepare for pull command (1414) to STB 106 identifying the media content to be streamed and related information, such as type of media, format, identity of the device (e.g., PC 104) from which the media item will be streamed, etc. In response to the prepare command (1406) and the prepare for pull command (1414), STB 106 may respond with OK messages (1408) and (1416), respectively, indicating successful reception of the commands.

Mobile phone 102 may stream the selected media item to PC 104 (block 1350). For example, mobile phone 102 may generate and transmit one or more stream data SETP commands (1418). The stream data SETP commands (1418) may include payload information that includes the requested media item. PC 104 may receive the media stream and may transcode the media stream in accordance with the received prepare to accept and transcode command (1410) (block 1360). The transcoded media stream may be stored in, e.g., a buffer or other data structure, prior to transmission to STB 106. For example, PC 104 may receive a stream including a .mov video file and may transcode the stream into an .avi file format suitable for playback by STB 106. Specifics regarding the transcoding process may be received by PC 104 in the prepare to accept and transcode command (1410).

Responsive to the prepare for pull command (1414), STB 106 may request the transcoded media stream from PC 104 (block 1370). For example, media stream receiving logic 610 may transmit a start SETP command message (1422) to PC 104. In some implementations, STB 106 may also prepare for playback of the media item, for example by designating a buffer address for receiving the media stream. In response to the start command (1422), PC 104 may respond with an OK message (1424), indicating successful reception of the command.

PC 104 may stream the transcoded media stream to STB 106 (block 1380). For example, PC 104 may generate and transmit one or more stream data SETP commands (1426) to STB 106. Media stream receiving logic 610 at STB 106 may receive the transcoded media stream (block 1390). Media output/playback logic 620 may display or output the media stream to, e.g., TV 108. For example, media output/playback logic 620 may display the received media stream via output device 370.

In some instances, such as in the event of lost packets or other command messages from mobile phone 102, PC 104 and/or STB 106 may transmit an error command or subcommand (1420)/(1428). Error commands (1420)/(1428) may notify mobile phone 102 that an expected packet (or packets) has not been received, that processing by PC 104/STB 106 has been interrupted, etc. Response to a received error message, mobile phone 102 may notify the user that the requested activity (e.g., streaming of the selected media item to STB 106) has failed.

At any time during media item streaming, mobile phone 102 may transmit terminate or stop commands (or subcommands) (1430/1434) to PC 104/STB 106, respectively, indicating that the media stream should be terminated. For example, mobile phone 102 may receive a back or stop command from the user via, for example, one of control keys 208. In response to the terminate commands (1430/1434), PC 104/STB 106 may respond with OK messages (1432/1436) indicating successful reception of the command.

FIGS. 15A-15E depict exemplary graphical user interfaces (GUIs) on mobile phone 102 consistent with implementations described above in relation to FIGS. 13 and 14. As illustrated, FIG. 15A illustrates a menu-driven GUI 1500 that provides users with a local media selection 1505 (e.g., for viewing/playing media stored on mobile phone 102) or a PC media selection 1510 (e.g., for viewing/playing media stored on PC 104).

For this example, assume that the user has selected local media selection 1505 (as represented by the highlighting in FIG. 15A). In response, mobile phone 102 may provide GUI 1515 illustrated in FIG. 15B. As illustrated, GUI 1515 may provide users with a number of media selections relating to media available on mobile phone 102. More specifically, in one exemplary embodiment, GUI 1515 may provide users with a my music selection 1520, a my pictures selection 1525, a my videos selection 1530, and a my ringtones selection 1535.

For this example, assume that the user wishes to view their photos and has selected my pictures selection 1525. In response, mobile phone 102 may provide GUI 1540 illustrated in FIG. 15C. As illustrated, GUI 1540 may provide users with a listing 1545 of available photo playlists or albums, including an all photos selection 1550, a national geographic photos selection 1555, a digital art selection 1560, and a b'day party selection 1565. Each item in listing 1545 may be associated with a number of image files stored, e.g., on storage device 350 on mobile phone 102.

For this example, assume that the user wishes to view the national geographic photos and has selected national geographic photos selection 1555. In response, mobile phone 102 may provide GUI 1570 illustrated in FIG. 15D. As illustrated, GUI 1570 may provide users with a number of thumbnail images 1575 corresponding to images in the national geographic photo set. In other implementations, GUI 1570 may provide a text based listing of the images in the national geographic photo set. As illustrated, GUI 1570 may enable the user to select (e.g., by touching) a particular photo from the provided thumbnail images 1575. Upon selection of the particular photo, mobile phone 102 may enlarge the selected image to facilitate better viewing, as illustrated in GUI 1580 in FIG. 15E.

In one implementation, GUIs 1570 and 1580 may provide a backup on PC option 1585. As described above in relation to FIGS. 7 and 8, user selection of backup on PC option 1585 may cause mobile phone 102 to communicate with PC 104 and stream or otherwise transmit the selected media item (e.g., the selected photo) to PC 104 for storage. GUI 1585 may also provided a show on TV option 1590. User selection of show on TV option 1590, in a manner consistent with FIGS. 13 and 14, may cause mobile phone 102 to communicate with PC 104 and STB 106 and to cause PC 104 to stream or otherwise transmit the selected image to STB 106 for output via TV 108.

In one implementation, GUIs 1500, 1515, 1540, 1570, and 1580 may include touchscreen GUIs configured for user interaction via touch screen display 206. In other implementations, users may navigate GUIs 1500, 1515, 1540, 1570, and 1580 via control keys 208, keypad 210, voice control, motion control, etc.

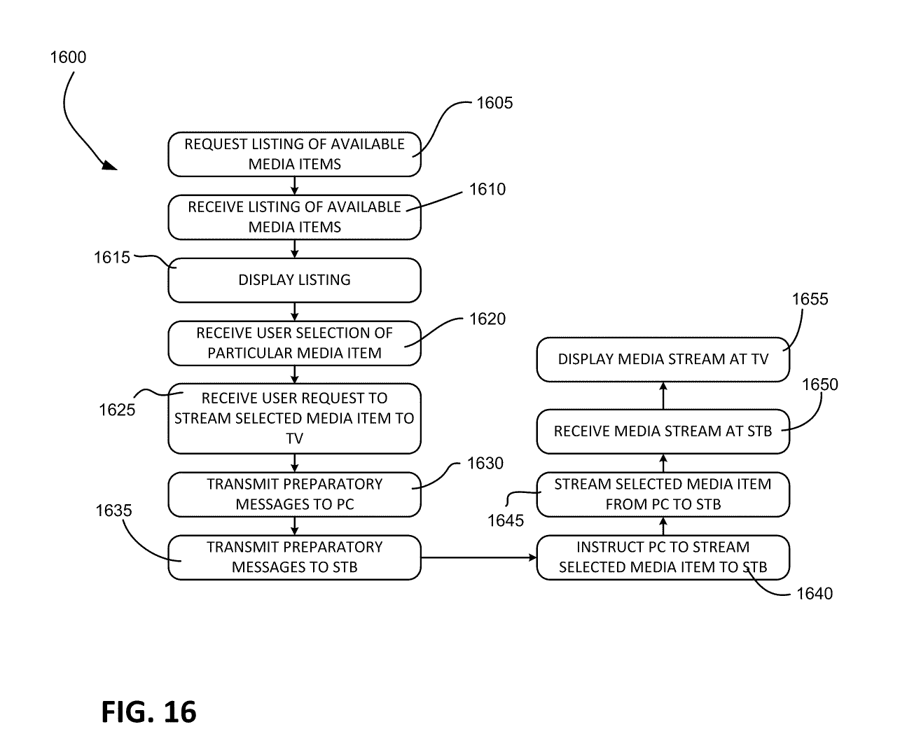

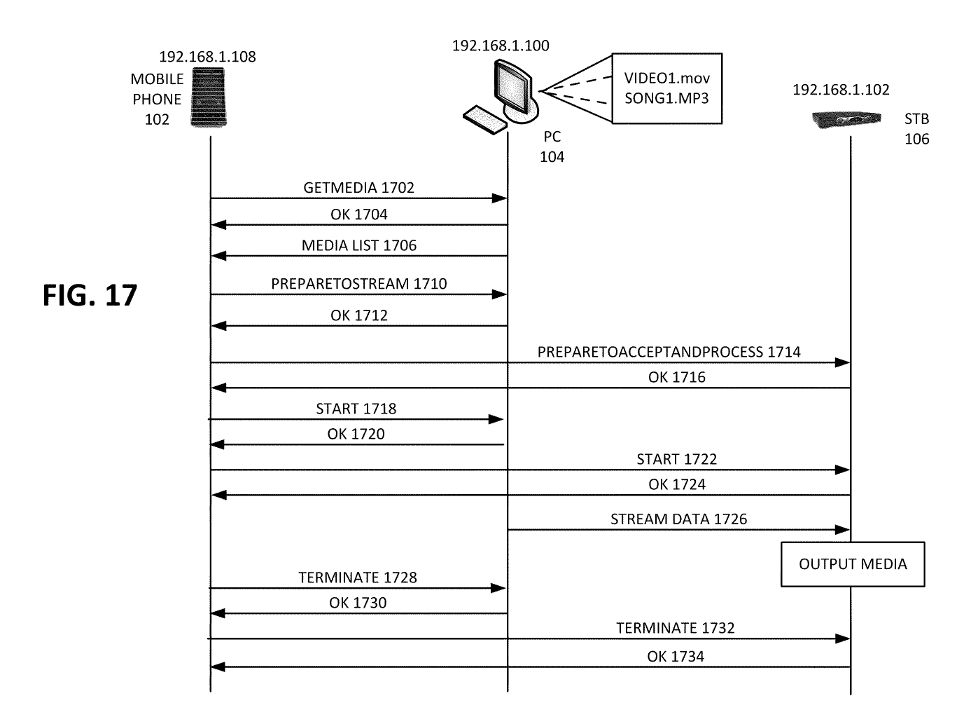

FIG. 16 is a flowchart of an exemplary process 1600 for displaying PC media across devices in network 110. Portions of process 1600 may be performed by mobile phone 102, PC 104 and/or STB 106. Process 1600 is described below with respect to FIG. 17, which is a signal diagram of exemplary messages sent between devices in network 110.

For the purposes of FIGS. 16 and 17, assume that mobile phone 102 and PC 104, mobile phone 102 and STB 106, and PC 104 and STB 106 have all successfully established communication sessions therebetween, e.g., using the processes described above with respect to FIGS. 7 and 8. Moreover, assume that PC 104 includes one or more media files or items, such as video1.mov and song1.mp3 available for playback via STB 106 via the established communication sessions.

Processing may begin with mobile phone 102 requesting a listing of available media from PC 104 (block 1605). In one implementation, mobile phone 102 may transmit a get media SETP command message (1702) to PC 104 via an established TCP session. In one implementation, the get media command message may be generated by media list retrieval logic 420 and may include an indication relating to the type of media list being requested, e.g., a list of shared photos, a list of shared music files, or a list of shared video files. Alternatively, the requested listing may include all available media items. Upon receipt of the get media SETP command (1702), PC 104 may initially respond with an OK message (1704) indicating successful reception of the request.

Mobile phone 102 may receive the requesting media listing from PC 104 (block 1610). In one implementation, the media listing may be received via one or more media list SETP messages (1706). In one implementation, the media list message (1706) may include payload data that includes media item information for media items associated with PC 104, such as file types, file names, file path information, etc.

Mobile phone 102 may display the received listing to the user (block 1615). For example, media list retrieval logic 420 may display the received media listing via output device 370, e.g., display 206. In some implementations, the displayed listing may include information associated with the media items, such as thumbnail images, etc. This media information may be transmitted to mobile phone 102 in the media list messages (1706), for example. In one implementation, media application 400 may provide a graphical or menu driven interface, e.g., via output device 370, that displays a listing of the available media items.

Mobile phone 102 may receive a user selection of a particular media item (block 1620). For example, media application 400 may receive a user selection of an item in the provided listing. Mobile phone 102 may receive a user request to stream or otherwise output the selected media item to a television (block 1625). For example, the provided interface may include a “stream to TV” option made available to the user upon selection of the media item. In response to the user request, mobile phone 102 may transmit one or more preparatory messages to PC 104 (block 1630) identifying the selected media item and various parameters regarding the stream. Mobile phone 102 may also transmit one or more preparatory messages to STB 106 to prepare the STB 106 to receive the transmitted media item (block 1635).

For example, mobile phone 102 may transmit a prepare to stream SETP command (1710) to PC 104 and a prepare to accept and process command (1714) to STB 106 via the respective established TCP sessions. The prepare to stream (1710) and prepare to accept and process (1714) commands may designate and/or include information regarding the media item to be streamed. In response to the prepare to stream (1710) and prepare to accept and process commands (1714), PC 104 and STB 106, respectively, may respond with OK messages (1712) and (1716), respectively, indicating successful reception of the commands.

Mobile phone 102 may instruct PC 104 to stream the selected media item to STB 106 (block 1640). For example, mobile phone 102 may transmit start commands (1718/1722) to PC 104 and STB 106 indicating that the media stream identified in prepare to stream command 1710 and prepare to accept and process command 1714 should be initiated. In response to the prepare start commands (1718/1722), PC 104 and STB 106, respectively, may respond with OK messages (1720) and (1702), respectively, indicating successful reception of the commands.

PC 104 may stream the selected media item to STB 106 (block 1645). For example, in response to start command (1718), PC 104 may generate and transmit one or more stream data SETP commands (1726) to STB 106. The stream data SETP commands (1726) may include payload information that includes the requested media item. STB 106 may receive the media stream (block 1650). The received media stream may be stored in, e.g., a buffer or other data structure, prior to transmission to being output or displayed, e.g., via TV 108.

Media output/playback logic 620 at STB 106 may display or output the media stream to, e.g., TV 108 (block 1655). For example, media output/playback logic 620 may display the received media stream via output device 370.

At any time during media item streaming, mobile phone 102 may transmit terminate or stop commands (or subcommands) (1728/1732) to PC 104/STB 106, respectively, indicating that the media stream should be terminated. For example, mobile phone 102 may receive a back or stop command from the user. In response to the terminate commands (1728/1732), PC 104/STB 106 may respond with respective OK messages (1730/1734) indicating successful reception of the command.

FIGS. 18A-18C depict exemplary GUIs on mobile phone 102 consistent with implementations described above in relation to FIGS. 16 and 17. As illustrated, FIG. 18A illustrates a menu-driven GUI 1800 that provides users with a local media selection 1805 (e.g., for viewing/playing media stored on mobile phone 102) or a PC media selection 1810 (e.g., for viewing/playing media stored on PC 104).

For this example, assume that the user has selected PC media selection 1810 (as represented by the highlighting in FIG. 18A). In response, mobile phone 102 may provide GUI 1815 illustrated in FIG. 18B. As illustrated, GUI 1815 may provide users with a number of media selections relating to media available on PC 104. More specifically, in one exemplary embodiment, GUI 1815 may provide users with a PC music selection 1820, a PC pictures selection 1825, and a PC videos selection 1830.

For this example, assume that the user wishes to view PC videos and has selected PC videos selection 1830. In response, mobile phone 102 may provide GUI 1835 illustrated in FIG. 18C. As illustrated, GUI 1835 may provide users with a listing 1840 of video files available on PC 104, including Ice Age 3—HD Trailer 1845, Gladiator—Russell Crowe 1850, My Web Cam Clip2—9 Oct. 2009 1855, and Mithramaranam—Indian Short Film 1860. For this example, assume that the user selects My Web Cam Clip2—9 Oct. 2009 1855.

In one implementation, GUI 1835 may provide a play option 1865 and a stream to TV option 1870. As described above in relation to FIGS. 9 and 10, user selection of play option 1865 may cause mobile phone 102 (e.g., media application 400) to communicate with PC 104 (e.g., media manager application 500) and cause PC 104 to stream or otherwise transmit the selected media item (e.g., the selected video) to mobile phone 102. Mobile phone 102 may output or display the received media stream, e.g., on display 206.

As described above in relation to FIGS. 16 and 17, user selection of stream to TV option 1870, may cause mobile phone 102 to communicate with PC 104 and STB 106 and to cause PC 104 to stream or otherwise transmit the selected media item to STB 106 for output via TV 108.

In one implementation, GUIs 1800, 1815, and 1835 may include touchscreen GUIs configured for user interaction via touch screen display 206. In other implementations, users may navigate GUIs 1800, 1815, and 1835 via control keys 208, keypad 210, voice control, motion control, etc.

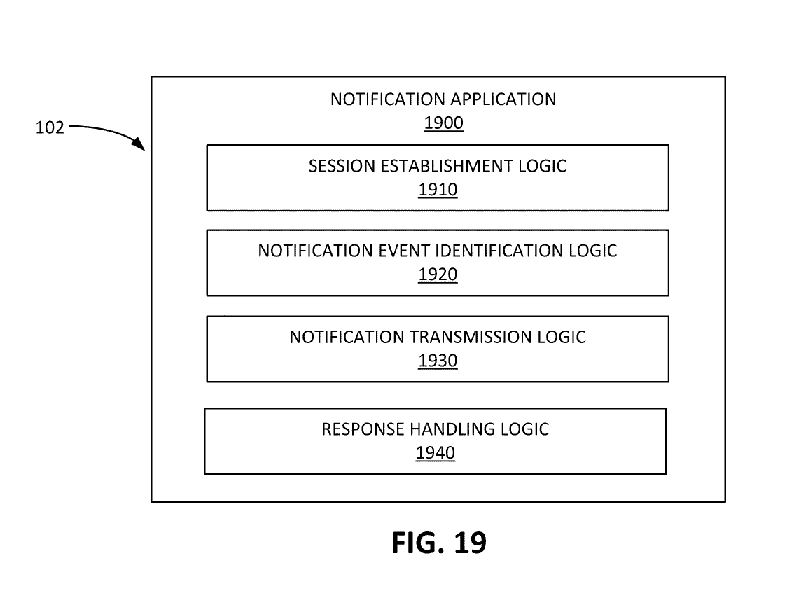

FIG. 19 is another exemplary functional block diagram of components implemented in mobile phone 102 of FIG. 1. In an exemplary implementation, all or some of the components illustrated in FIG. 19 may be stored in memory 330. Memory 330 of mobile phone 102 may include a notification application 1900 that includes session establishment logic 1910, notification event identification logic 1920, notification transmission logic 1930, and response handling logic 1940. In addition, various logic components illustrated in FIG. 19 may be implemented by processing logic 220 executing one or more programs stored in memory 330. In some implementations, one or more components of FIG. 19 may be implemented in other devices, such as STB 106.

Notification application 1900 may include a suitable combination of software and hardware configured to enable mobile phone 102 to transmit event notifications via network 110 to STB 106 for viewing on TV 108. Session establishment logic 1910 may include logic configured to establish one or more communication sessions between mobile phone 102 and/or STB 106 for facilitating display of mobile phone notification information on TV 108.

In one exemplary implementation, session establishment logic 1910 may use SETP sessions via WLAN (e.g., WiFi) network 110 to facilitate communications and data exchange between mobile phone 102 and STB 106. As described above, SETP commands may enable device discovery and interaction using a defined set of messages and commands exchanged between devices. In other implementations, other communication protocols, such as the Bluetooth® protocol may be used to facilitate communication session and message format between mobile phone 102 and STB 106. In this implementation, session establishment logic 1910 may require that mobile phone 102 be “paired” or otherwise associated with STB 106. Subsequent post-pairing communications may be performed with little or no interaction on the part of the user.

Notification event identification logic 1920 may include logic configured to monitor and identify event conditions associated with mobile phone 102, such as incoming call events, call waiting events, messaging events (e.g., text messaging, instant messaging, email, etc.), device status event (e.g., battery status, signal strength (e.g., WiFi signal strength), calendar events, etc. In one implementation consistent with implementations described herein, the events monitored and identified by notification event identification logic 1920 may be based on user configurable notification preferences. For example, mobile phone 102 may provide an interface (e.g., a GUI) for enabling a user to select from a number of available event notifications, notification frequencies, information provider, notification style, etc.

Notification transmission logic 1930 may receive notification event identification information from notification event identification logic 1920 and may transmit the notifications to STB 106 via the communication session established by session establishment logic 1910 (e.g., a SETP-based TCP session, a Bluetooth® session, etc.). For example, for a SETP-based communication session, notification transmission logic 1930 may generate and transmit a command message designating the type of event notification being received and information relating to the event, such as caller ID information, text message content information, email sender information, etc.

In one implementation, notification transmission logic 1930 may format the notifications based on the configured notification preferences. For example, for a received text message notification, the notification preferences may indicate that an alert only is to be transmitted to STB 106. Alternatively, the notification preferences may indicate that the sender and/or the text (e.g., body) of the text message is to be included with the transmitted notification. Similarly, for an incoming call notification, the notification preferences may indicate that a caller ID information for the call is to be transmitted to STB 106.

Response handling logic 1940 may include logic configured to receive one or more messages from STB 106 responsive to the transmitted notifications. For example, response handling logic 1940 may receive a reply message from STB 106 indicating that mobile phone 102 should reply to a received text message with content included in the reply message.

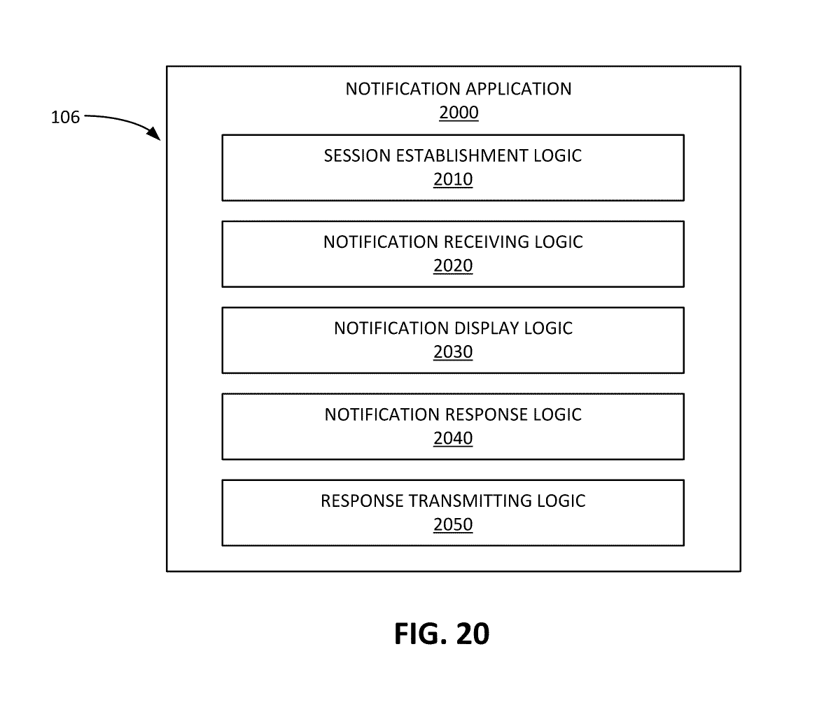

FIG. 20 is another exemplary functional block diagram of components implemented in STB 106 of FIG. 1. In an exemplary implementation, all or some of the components illustrated in FIG. 20 may be stored in memory 330. Memory 330 of STB 106 may include a notification application 2000 that includes session establishment logic 2010, notification receiving logic 2020, notification display logic 2030, notification response logic 2040, and response transmitting logic 2050. In addition, various logic components illustrated in FIG. 20 may be implemented by processing logic 220 executing one or more programs stored in memory 330. In some implementations, one or more components of FIG. 20 may be implemented in other devices, such as TV 108.

Notification application 2000 may include a suitable combination of software and hardware configured to enable STB 106 to receive event notifications via network 110 from mobile phone 102 and output the received notifications to TV 108. In some implementations, notification application 2000 may be configured to provide an interface for receiving responses or other actions relating to the received notifications.

Session establishment logic 2010 may include logic configured to establish one or more communication sessions with mobile phone 102 for facilitating reception and display of mobile phone notification information from mobile phone 102. In one exemplary implementation, session establishment logic 2010 may coordinate with mobile phone 102 to establish a SETP (TCP) session with mobile phone 102 via WLAN (e.g., WiFi) network 110. In other implementations, other communication protocols, such as the Bluetooth® protocol may be used to facilitate communication session and message format between mobile phone 102 and STB 106. In this implementation, session establishment logic 2010 may require that mobile phone 102 be “paired” or otherwise associated with STB 106. Subsequent post-pairing communications may be performed with little or no interaction on the part of the user.

Notification receiving logic 2020 may include logic configured to receive event notifications from mobile phone 102 via network 110. For example, for a SETP-based communication session, notification receiving logic 2020 may receive a command message designating the type of event notification being received and information relating to the event, such as caller ID information, text message content information, email sender information, etc.

Notification display logic 2030 may include logic configured to output information relating to the received event notification, e.g., to TV 108. For example, notification display logic 2030 may extract information from the received event notification, format the information for display on TV 108, and output the information to TV 108 e.g., via a GUI associated with STB 106.

Notification response logic 2040 may include logic configured to receive one or more responses from the user in response to the output event notification. For example, notification response logic 2040 may receive user interactions relating to the provided event responses. For example, as described above, notification response logic 2040 may receive response information, such as a user command to reply to a received text message notification, close the notification, read the content of a received text message or email, etc. In such an example, STB 106 (e.g., notification response logic 2040) may provide an interface for facilitating the receipt of text message information, such as a soft or on-screen keyboard, a listing of predefined response messages, etc. Response transmitting logic 2050 may include logic configured to transmit the event response information to mobile phone 102 via the established communication session.

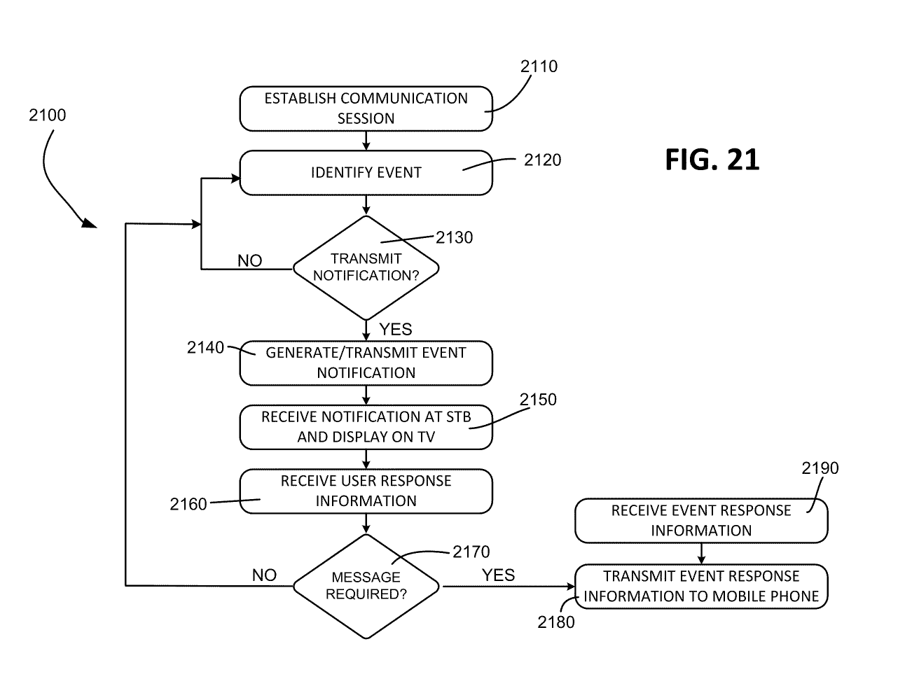

FIG. 21 is a flowchart of an exemplary process 2100 for displaying mobile phone event notifications on a television across devices in a network. Portions of process 2100 may be performed by mobile phone 102 and/or STB 106. Processing may begin with mobile phone 102 establishing a communication session with STB 106 (block 2110). For example, as described above, session establishment logic 1910 in mobile phone 102 may establish a SETP-based session with session establishment logic 2010 in STB 106 in the manner described above in relation to FIGS. 7 and 8. Alternatively, mobile phone 102 may establish a Bluetooth® or other WLAN-based session with STB 106.

Mobile phone 202 may identify an event (block 2120) and may determine whether a notification regarding the identified event should be transmitted to STB 106 for display on TV 108 (block 2130). For example, notification event identification logic 1920 may monitor mobile phone events and may determine whether a monitored event has been selected for notification to STB 106, based on, for example, the user configured notification preferences. If no notification is to be transmitted to STB 106 (block 2130—NO), processing returns to block 2120 for a next event identification.

If it is determined that a notification should be transmitted to STB 106 (block 2130—YES), mobile phone 102 may generate and transmit an event notification to STB 106 (block 2140). For example, notification transmission logic 1930 may generate and transmit one or more event notification messages to, for example, notification receiving logic 2020 via the established communication session. In some implementations, the transmitted event notification may include information associated with the triggering event, such as the text of an email or text message, the caller information for a received or missed telephone call or voicemail, etc.

STB 106 may receive and display the received event notification on TV 108 (block 2150). For example, notification display logic 2030, in response to the received event notification, and pursuant to stored configuration information, may output the received event notification to TV 108.

STB 106 may receive user response information responsive to the displayed event notification (block 2160). For example, notification response logic 2040 may receive user commands, e.g., via a remote control or other input device associated with STB 106. Exemplary user response may include a reply command for replying to a text or email message, a read command for reading a email or text message, an open command for opening a file, a view command for viewing a received image, etc.

STB 106 may determine whether the received response requires that a message be transmitted to mobile phone 102 (block 2170). If not (block 2170—NO), processing returns to block 2120 for a next event identification. If the received response requires that a message be transmitted to mobile phone 102 (block 2170—YES), STB 106 may transmit the received user response information to mobile phone 102 (block 2180). For example, response transmitting logic 2050 may generate and transmit one or more event response messages to response handling logic 1940 in mobile phone 102 via the established communication channel.

Response handling logic 1940 may receive and process the received event response information (block 2190). For example, response handling logic 1940 may interact with the user to generate and transmit a text or email message, initiate a call, etc.

In the embodiments described above, a user of a mobile phone or other portable communication device may initiate the distribution and display or playback of media on various devices across via established communication sessions on a network. For example, a user of mobile phone 102 may view media content stored on PC 104 and may selectively display the content on mobile phone 102 or television 108. Similarly, a user of mobile phone 102 may display media items stored on mobile phone 102 on television 108, with transcoding by PC 104, where necessary. In other implementations, the user may back up media content from mobile phone 102 to PC 104, or from PC 104 to mobile phone 102. Furthermore, mobile phone 102 may transmit event notifications, such as call and messaging notifications, for display on television 108.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

While series of blocks have been described above with respect to different processes, the order of the blocks may differ in other implementations. Moreover, non-dependent acts may be performed in parallel.

It will be apparent that aspects of the embodiments, as described above, may be implemented in many different forms of software, firmware, and hardware in the embodiments illustrated in the figures. The actual software code or specialized control hardware used to implement these embodiments is not limiting of the invention. Thus, the operation and behavior of the embodiments of the invention were described without reference to the specific software code—it being understood that software and control hardware may be designed to the embodiments based on the description herein.

Further, certain portions of the invention may be implemented as “logic” that performs one or more functions. This logic may include hardware, such as an application specific integrated circuit, a field programmable gate array, a processor, or a microprocessor, or a combination of hardware and software.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

What is claimed is:

1. A method for displaying media items via a network, wherein the network includes a mobile device, a personal computer, and a set-top box connected to a television, the method comprising:
establishing a first communication session with the personal computer via the network;
identifying a media item for display on the television; and
transmitting a request to the personal computer to output the identified media item for display on the television.

2. The method of claim 1, wherein establishing the first communication session with the personal computer comprises:
transmitting a broadcasting message across the network;
establishing the first communication session with the personal computer in response to the broadcasting message being received by the personal computer; and
authenticating the first communication session.

3. The method of claim 2, wherein the broadcast message comprises a user datagram protocol (UDP) message and the first communication session comprises a transmission control protocol (TCP) session.

4. The method of claim 1, wherein the network comprises a wireless network.

5. The method of claim 2, wherein authenticating the first communication session comprises:
receiving a first encrypted key and a nonce value from the personal computer, wherein the encrypted key is based on the nonce value;
generating a second encrypted key based on the received nonce value and information shared between the mobile device and the personal computer;
comparing the second encrypted key to the first encrypted key; and
determining that the first communication session is authenticated when the second encrypted key matches the first encrypted key.

6. The method of claim 5, wherein the information shared between the mobile device and the personal computer comprises user identification information.

7. The method of claim 5, wherein the first encrypted key and the second encrypted key comprise secure hashing algorithm (SHA-1) keys.

8. The method of claim 1, further comprising:
requesting a list of available media items from the personal computer via the first communication session;
receiving the list of available media items from the personal computer via the first communication session; and
receiving a selection of the identified media item from the list of available media items.

9. The method of claim 8, further comprising:
establishing a second communication session with the set-top box via the network; and
transmitting a prepare message designating the selected media item to the set-top.

10. The method of claim 8, wherein a third communication session is established between the personal computer and the set-top box, and wherein transmitting the request to the personal computer to output the identified media item for display on the television comprises:
transmitting a request identifying the selected media item to the personal computer,
wherein the personal computer, responsive to the request, transmits the selected media item to the set-top box via the third communication session.

11. The method of claim 1, further comprising:
retrieving a list of available media items from a memory associated with the mobile device; and
receiving a selection of the identified media item from the retrieved list of available media items.

12. The method of claim 11, wherein a third communication session is established between the personal computer and the set-top box, and wherein transmitting the request to the personal computer to output the identified media item for display on the television comprises:
transmitting the selected media item to the personal computer,
wherein the personal computer, responsive to the received media item, transmits the selected media item to the set-top box via the third communication session.

13. The method of claim 12, wherein the personal computer, responsive to the received media item, transcodes the media item from a first format to a second format prior to transmitting the media item to the set-top box.

14. The method of claim 13, wherein transmitting the selected media item to the personal computer and transmitting the selected media item to the set-top box via the third communication session comprise streaming.

15. The method of claim 1, wherein the media item comprises a video file, an image file, or an audio file.

16. A system comprising:
a personal computer;
a set-top box; and
a mobile device including:
a mobile device communication interface configured to exchange information with the personal computer and the set-top box via a network,
a mobile device output interface for displaying a user interface to a user; and
mobile device logic to:
establish a first communication session with the personal computer via the mobile device communication interface;
display a listing of available media items on the mobile device output interface;
identify a user selection of a particular media item; and
transmit a request to the personal computer via the first communication session to output the particular media item to the set-top box for display on the television;
wherein the personal computer includes:
a personal computer communication interface configured to exchange information with the mobile device and the set-top box via the network; and
personal computer logic to:
establish the first communication session with the mobile device via the personal computer communication interface;
establish a second communication session with the set-top box via the personal computer communication interface;
receive, via the first communication session, the request to output the particular media item to the set-top box for display on the television from the mobile device; and
transmit, via the second communication session, the particular media item to the set-top box;
wherein the set-top box includes:
a set-top box communication interface configured to exchange information with the mobile device and the personal computer via the network;
a set-top box output interface for outputting the particular media item to the television; and
set-top box logic to:
establish the second communication session with the personal computer via the set-top box communication interface;
receive, via the second communication session, the particular media item from the personal computer; and
output the particular media item to the television via the set-top box output interface.

17. The system of claim 16, wherein the mobile device logic is further configured to:
establish a third communication session with the set-top box via the mobile device communication interface; and
transmit a prepare message to the set-top box via the third communication session,
wherein the prepare message designates the particular media item.

18. The system of claim 17, wherein the first communication session, the second communication session, and the third communication session comprise wireless transport control protocol (TCP) sessions based on an extensible command protocol.

19. The system of claim 18, wherein the personal computer logic is further configured to:
convert the particular media item from a first format to a second format prior to transmitting the particular media item.

20. The system of claim 16, wherein the mobile device logic is further configured to:
retrieve the listing of available media items from the personal computer via the first communication session.

21. The system of claim 16, wherein the available media items are stored on a memory associated with the mobile device,
wherein the mobile device logic is further configured to retrieve the listing of available media items from the memory.

22. The system of claim 21, wherein the mobile device logic is further configured to:
stream the particular media item to the personal computer via the first communication session,
wherein the personal computer logic is further configured to stream, via the second communication session, the received particular media item to the set-top box.

23. A method, comprising:
establishing a wireless communication session with a set-top box connected to a television;
identifying an event occurrence; and
transmitting a notification indicative of the event occurrence to the set-top box for display on the television.

24. The method of claim 23, further comprising:
determining whether the notification should be transmitted to the set-top box based on notification preference information; and
transmitting the notification to the set-top box when it is determined that the notification should be transmitted to the set-top box.

25. The method of claim 23, further comprising:
receiving event response information from the set-top box, wherein the event response information is based on user interaction received in response to display of the notification; and
handling the received event response information.
